(19) United States
(12) Patent Application Publication
(10) Pub. No.: US 2017/0316385 A1
(43) Pub. Date: Nov. 2, 2017

(54) CONTEXTUALLY-AWARE INSIGHTS FOR CALENDAR EVENTS

(71) Applicant: Microsoft Technology Licensing, LLC, Redmond, WA (US)

(72) Inventors: Neel Joshi, Kirkland, WA (US); William Hart Holmes, Seattle, WA (US); Paul David Tischhauser, Redmond, WA (US); Chandresh K. Jain, Sammamish, WA (US); Mohit Mehtani, Redmond, WA (US); Tor-Helge Persett, Seattle, WA (US); Eva Britta Karolina Burlin, Newcastle, WA (US); Dana Anne Lee, Seattle, WA (US); Joan Ching Li, Seattle, WA (US)

(21) Appl. No.: 15/142,513

(22) Filed: Apr. 29, 2016

(51) Int. Cl. G06Q 10/10; G01C 21/26

(52) U.S. Cl. CPC G06Q 10/1095; G01C 21/26

(57) ABSTRACT

Techniques described herein provide contextually-aware insights into calendar events. Generally described, the techniques disclosed herein can analyze a wide variety of contextual data including, but not limited to, weather data, traffic data, location data, performance data, preference data, and scheduling data, to generate salient insights that can be automatically displayed and/or communicated to a user. Insights related to one or more calendar events may be generated in response to a discovery of a predetermined condition. A predetermined condition may be detected at the time an appointment is made or at a later time when contextual data indicates a change in one or more conditions. An insight can include a text description, an image, a graphical indicator, a generated voice, and any other suitable form of communication describing useful information regarding one or more calendar events. An insight can include ranked list of recommendations can also be displayed.

### BACKGROUND

Computer users utilize calendaring programs to schedule appointments, maintain records, and communicate information with one another. Although existing calendaring programs provide many features for scheduling appointments, existing technologies can be somewhat encumbering when it comes to the efficiencies of human interaction. For instance, when a user encounters a scheduling conflict, some systems are limited in how scheduling conflicts are displayed and resolved. In some systems, a notification of a scheduling conflict can simply show a graphical element indicating that two calendar events conflict with one another. Some systems can also display graphical elements showing timelines for individual calendar events.

Although some existing programs can show that two or more appointments conflict with one another, users are required to manually adjust individual calendar events to resolve such conflicts. The challenges of such tasks can be exacerbated by the fact that some user interface designs only show a limited amount of information. Such limitations can raise more challenges for users trying to coordinate multiple events. When such scenarios are presented, a user experience with some existing calendaring programs can be less than optimal. Such scenarios can lead to poorly planned schedules, which in turn can create a lengthy chain reaction of other inefficiencies.

It is with respect to these and other considerations that the disclosure made herein is presented.

### SUMMARY

Techniques described herein provide contextually-aware insights into calendar events. Generally described, the techniques disclosed herein can analyze different types of contextual data including, but not limited to, weather data, traffic data, location data, performance data, preference data, and scheduling data, to generate salient insights that can be automatically displayed and/or communicated to a user. An insight can include a text description, an image, a graphical indicator, a generated voice, and any other suitable form of communication describing useful information regarding one or more calendar events. For example, an insight can provide salient facts regarding the nature of a scheduling conflict, preferences of one or more users, an update to one or more calendar events, and/or updates to conditions that can affect one or more calendar events. Data defining one or more insights related to the conditions can be communicated to computers and/or users in many different ways, including but not limited to, emails, notifications, reminders, appointments, modifications to appointments etc.

Insights related to one or more calendar events may be generated in response to a discovery of a condition. A condition may be detected at the time an appointment is made or at a later time when contextual data indicates a change presence of one or more predetermined conditions. In some configurations, a system can monitor contextual data related to one or more calendar events. If a predetermined condition is detected, the techniques disclosed herein may generate data describing an insight to the detected condition. For example, a system can analyze two or more calendar events to determine the presence of a conflict. In one illustrative example, a conflict may arise if two calendar events overlap one another. In other examples, two or more calendar events may create a conflict based on a number of other factors, which may be influenced by weather, traffic, road closures, and conditions presented in received contextual data, such as performance data, location data, and other data.

In some configurations, the techniques disclosed herein can analyze aspects of two or more calendar events to determine a location associated with a given calendar event and locations associated with calendar events preceding and following the given calendar event. Traffic data, weather data, scheduling data, and other contextual data can be analyzed to determine if a commute between two or more appointments is possible. In some configurations, data defining a probability of a commute can be determined. The probability of the commute and other factors may be utilized to determine a severity of a conflict. In addition, the contextual information may be analyzed to generate data defining an insight. An insight may provide a text description of a conflict, an image or illustration of a conflict, a description of a conflict, a description of a probability of a commute, a description of a severity level, etc.

In some configurations, an insight generated by the techniques disclosed herein can describe events, conflicts, actions and/or scenarios explaining aspects of a condition as well as a ranked list of proposed resolutions to address the condition. Resolutions to the conflict may include recommendations for a new appointment, recommendations for a new customer, recommendations for a new provider, a generation of any type of communication providing notice of a scheduling conflict, and other forms of output data.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 is a block diagram showing an illustrative system for providing contextually-aware insights into calendar events.

FIGS. 2A-2D include screen diagrams showing an illustrative graphical user interface that is configured with graphical elements for displaying insights related to a calendar event.

FIGS. 3A-3C include screen diagrams showing an illustrative graphical user interface that is configured with graphical elements for displaying insights related to a calendar event.

FIGS. 4A-4C include screen diagrams showing an illustrative graphical user interface that is configured with graphical elements for displaying insights including workflow data and map data.

FIG. 5 is a flow diagram showing a routine illustrating aspects of a routine disclosed herein for providing contextually-aware insights into calendar events.

FIG. 6 is a computer architecture diagram illustrating an illustrative computer hardware and software architecture for a computing system capable of implementing aspects of the techniques and technologies presented herein.

FIG. 7 is a diagram illustrating a distributed computing environment capable of implementing aspects of the techniques and technologies presented herein.

FIG. 8 is a computer architecture diagram illustrating a computing device architecture for a computing device capable of implementing aspects of the techniques and technologies presented herein.

### DETAILED DESCRIPTION

The following Detailed Description describes technologies providing contextually-aware insights into calendar events. Generally described, the techniques disclosed herein can analyze different types of contextual data including, but not limited to, weather data, traffic data, location data, performance data, preference data, and scheduling data, to identify salient insights that can be automatically displayed and/or communicated to a user. An insight can include a text description, an image, a graphical indicator, a generated voice, and any other suitable form of communication describing useful information regarding one or more calendar events. For example, an insight can provide salient facts regarding the nature of a scheduling conflict, preferences of one or more users, an update to one or more calendar events, and updates to conditions that can affect one or more calendar events. Data defining one or more insights related to the conditions can be communicated to computers and/or users in many different ways, including but not limited to, emails, notifications, reminders, appointments, modifications to appointments etc.

Insights related to one or more calendar events may be generated in response to a discovery of a predetermined condition. A predetermined condition may be detected at the time an appointment is made or at a later time when contextual data indicates a change in one or more conditions. In some configurations, a system can monitor contextual data related to one or more calendar events. If a predetermined condition is detected, the techniques disclosed herein may generate data describing an insight to the detected conditions. For example, a system can analyze two or more calendar events to determine the presence of a conflict. In one illustrative example, a conflict may arise if two calendar events overlap one another. In other examples, two or more calendar events may create a conflict based on a number of other factors, which may be influenced by weather, traffic, road closures, and conditions presented in received contextual data, such as performance data, location data, and other data.

In some configurations, the techniques disclosed herein can analyze aspects of two or more calendar events to determine a location associated with a given calendar event and locations associated with calendar events preceding and following the given calendar event. Traffic data, weather data, scheduling data, and other contextual data can be analyzed to determine if a commute between two or more appointments is possible. In some configurations, data defining a probability of a commute can be determined. The probability of the commute and other factors may be utilized to determine a severity of a conflict. In addition, the contextual information may be analyzed to generate data defining an insight. An insight may provide a text description of a conflict, an image or illustration of a conflict, a voice description of a conflict, etc.

In some configurations, an insight generated by the techniques disclosed herein can describe events, conditions, actions and/or scenarios explaining a nature of a scheduling conflict as well as a ranked list of proposed resolutions to a predetermined condition. Resolutions to the conflict may include recommendations for a new appointment, recommendations for a new customer, recommendations for a new provider, a generation of any type of communication providing notice of a scheduling conflict, and other forms of output data.

By the use of the technologies described herein, contextual data from a number of resources can be utilized to provide contextually-aware insights into calendar events. Such technologies can improve user interaction with a computing device by automatically generating and displaying insights of relevant information without requiring users to conduct a search or manually access a number of resources. The generation of the insights can be beneficial in assisting users that are coordinating aspects of a project, such as generating calendar events. Among many benefits provided by the technologies described herein, a user's interaction with a device may be improved, which may reduce the number of inadvertent inputs, reduce the consumption of processing resources, and mitigate the use of network resources. Other technical effects other than those mentioned herein can also be realized from implementations of the technologies disclosed herein.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

As will be described in more detail herein, it can be appreciated that implementations of the techniques and technologies described herein may include the use of solid state circuits, digital logic circuits, computer component, and/or software executing on one or more devices. Signals described herein may include analog and/or digital signals for communicating a changed state, movement and/or any data associated with motion detection. Gestures captured by users of the computing devices can use any type of sensor or input device.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

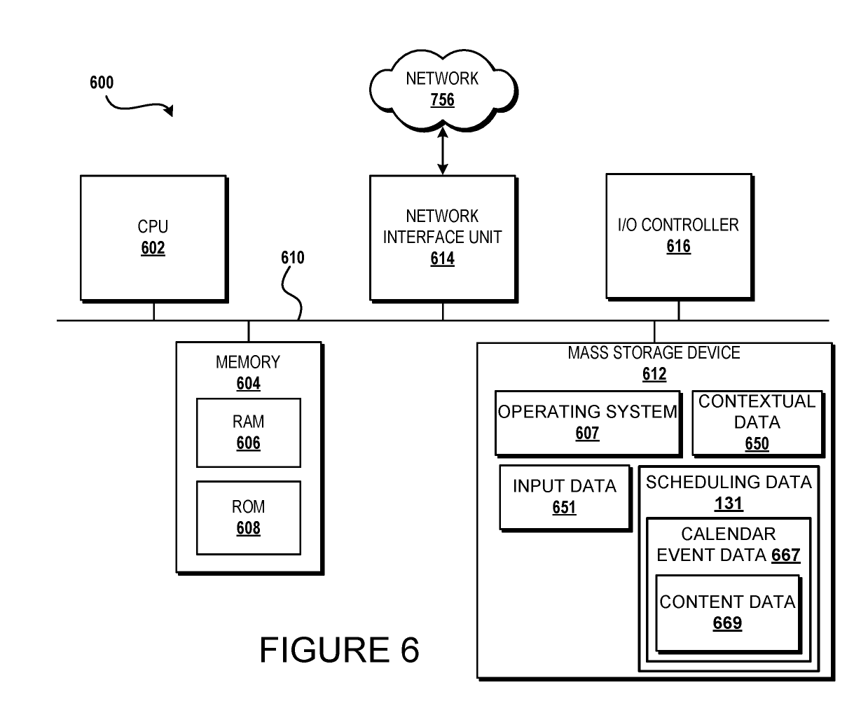

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for providing contextually-aware insights into calendar events. As will be described in more detail below with respect to FIGS. 6-8, there are a number of applications and services that can embody the functionality and techniques described herein.

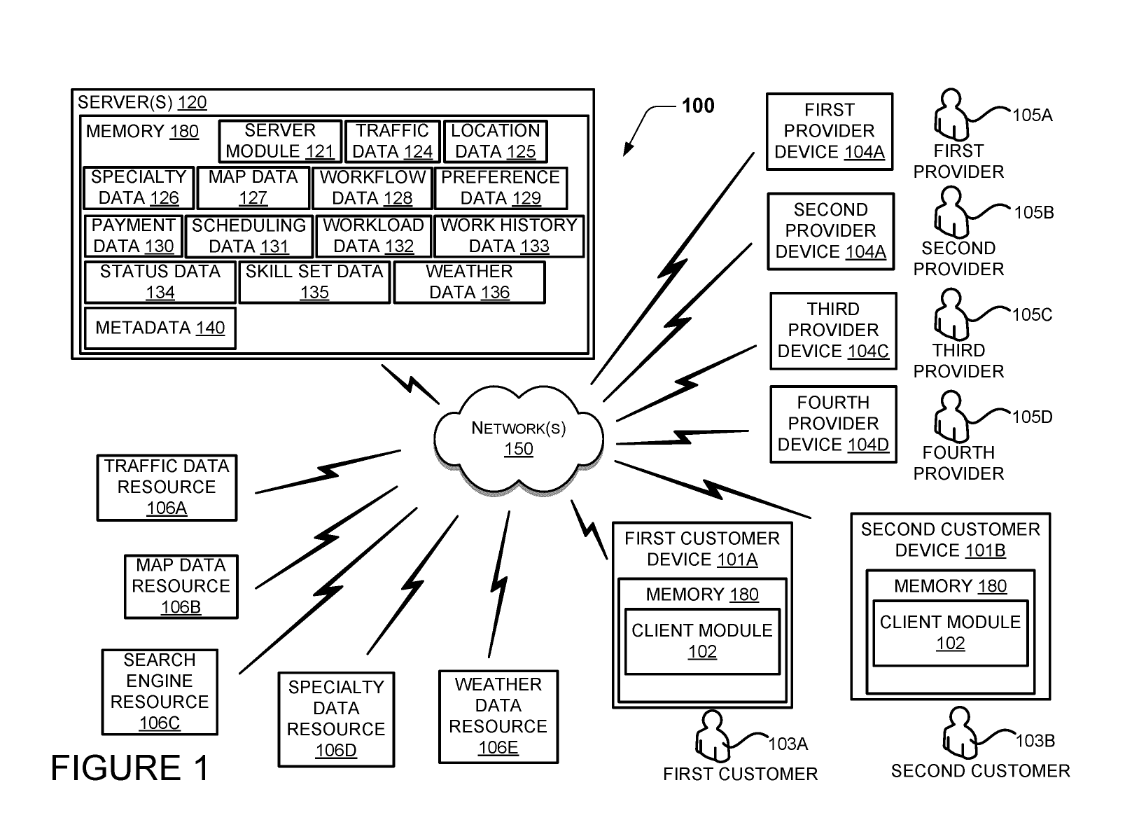

FIG. 1 is a block diagram showing aspects of one example environment 100, also referred to herein as a “system 100,” disclosed herein for providing contextually-aware insights into calendar events. In one illustrative example, the example environment 100 can include one or more servers 120, one or more networks 150, one or more customer devices 101A-101B (collectively “customer devices 101”), one or more provider devices 104A-104D (collectively “provider devices 104”), and one or more resources 106A-106E (collectively “resources 106”). The customer devices 101 can be utilized for interaction with one or more customers 103A-103B (collectively “customers 103”), and the provider devices 104 can be utilized for interaction with one or more service providers 105A-105D (collectively “service providers 105”). This example is provided for illustrative purposes and is not to be construed as limiting. It can be appreciated that the example environment 100 can include any number of devices, customers, providers, and/or any number of servers 120.

For illustrative purposes, the service providers 105 can be a company, person, or any type of entity capable of providing services or products for the customers 103, which can also be a company, person or other entity. For illustrative purposes, the service providers 105 and the customers 103 can be generically and individually referred to herein as “users.” In general, the techniques disclosed herein enable users to utilize contextual data from a number of resources 106 to generate workflow data 128 and other data objects related to the workflow data 128. In some configurations, a data object may include one or more calendar events related to stages of the workflow. Contextual data can be analyzed to determine one or more candidate timeslots for individual stages. The candidate timeslots can be ranked based on contextual data and a ranked list of candidate timeslots can be presented to the user for selection.

The customer devices 101, provider devices 104, servers 120 and/or any other computer configured with the features disclosed herein can be interconnected through one or more local and/or wide area networks, such as the network 150. In addition, the computing devices can communicate using any technology, such as BLUETOOTH, WIFI, WIFI DIRECT, NFC or any other suitable technology, which may include light-based, wired, or wireless technologies. It should be appreciated that many more types of connections may be utilized than described herein.

A customer device 101 or a provider device 104 (collectively “computing devices”) can operate as a stand-alone device, or such devices can operate in conjunction with other computers, such as the one or more servers 120. Individual computing devices can be in the form of a personal computer, mobile phone, tablet, wearable computer, including a head-mounted display (HMD) or watch, or any other computing device having components for interacting with one or more users and/or remote computers. In one illustrative example, the customer device 101 and the provider device 104 can include a local memory 180, also referred to herein as a “computer-readable storage medium,” configured to store data, such as a client module 102 and other contextual data described herein.

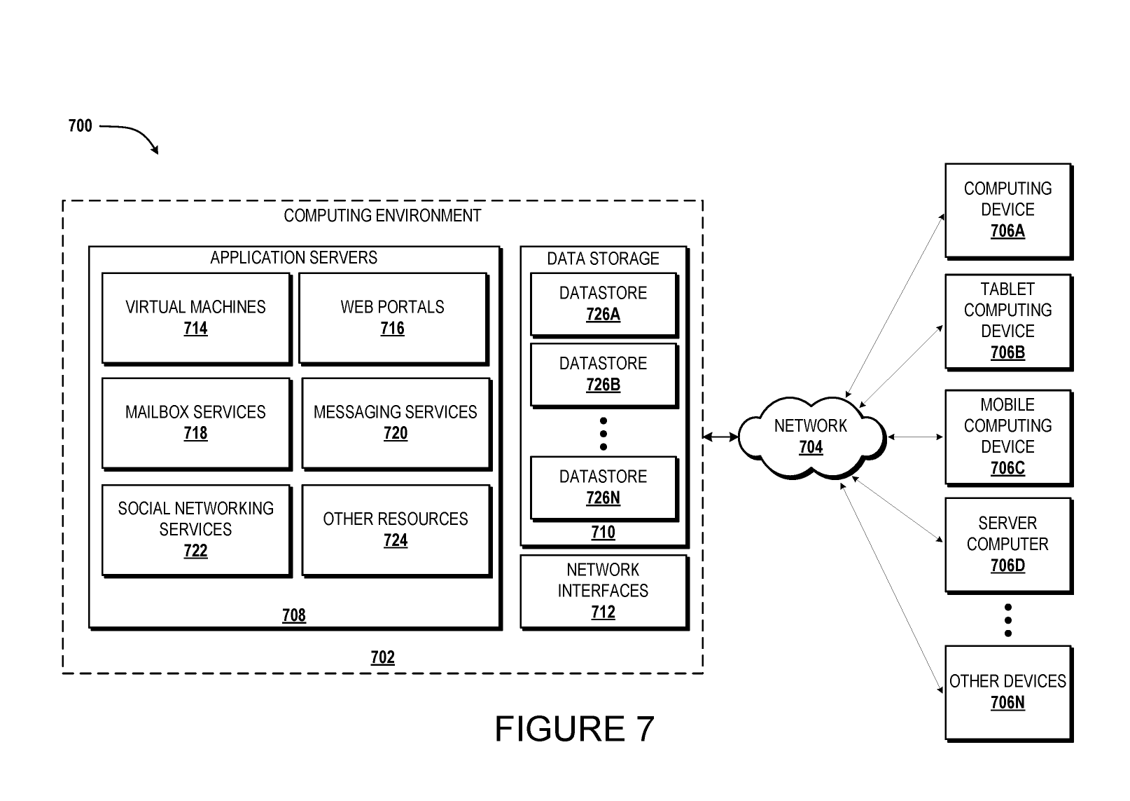

The servers 120 may be in the form of a personal computer, server farm, large-scale system or any other computing system having components for processing, coordinating, collecting, storing, and/or communicating data between one or more computing device. In one illustrative example, the servers 120 can include a local memory 180, also referred to herein as a “computer-readable storage medium,” configured to store data, such as a server module 121 and other data described herein. The servers 120 can also include components and services, such as the application services and shown in FIG. 7, for providing, receiving, and processing contextual data and executing one or more aspects of the techniques described herein. As will be described in more detail herein, any suitable module may operate in conjunction with other modules or devices to implement aspects of the techniques disclosed herein.

In some configurations, an application programming interface 199 (“API”) exposes an interface through which an operating system and application programs executing on the computing device can enable the functionality disclosed herein. Through the use of this data interface and other interfaces, the operating system and application programs can communicate and process contextual data to modify scheduling data as described herein.

The system 100 may include a number of resources, such as a traffic data resource 106A, map data resource 106B, search engine resource 106C, specialty data resource 106D, and a weather data resource 106E (collectively referred to herein as “resources 106”). The resources 106 can be a part of the servers 120 or separate from the servers 120, and the resources 106 can provide contextual data, including traffic data 124, location data 125, specialty data 126, map data 127, workflow data 128, preference data 129, payment data 130, scheduling data 131, workload data 132, work history data 133, status data 134, skill set data 135, weather data 136, and other data described herein. The metadata 140 can include, but is not limited to, a person's name, a company name, contact information, location data, and any other data related to a provider 105 or a customer 103. In some configurations, the metadata 140 can include any format suitable for populating one or more data entry fields of a user interface.

These example resources 106 and contextual data are provided for illustrative purposes and are not to be construed as limiting. It can be appreciated that the techniques disclosed herein may utilize more or fewer resources 106 shown in FIG. 1. It can also be appreciated that some of the resources shown in FIG. 1 can obtain any type of contextual information from other resources such as social networks, e-commerce systems, government systems, and other like sources. For instance, sales data from e-commerce systems can be used to determine a performance indicator of a customer or a provider.

The scheduling data 131 can define appointments for the customers 103 and the providers 105. The scheduling data 131 can define a start time and an end time. The scheduling data 131 can also include location data 125 if an appointment is associated with a geographic location, global coordinates, an address, a room number and other information identifying a location. The scheduling data 131 can define a single appointment or a series of appointments. In addition, the scheduling data 131 can include communication information such as a phone number, IM address, URL, or other information for facilitating a voice or video conference. The scheduling data 131 can also include a text description of an appointment and other data indicating a topic, service category, a customer 103 and/or a provider 105. The scheduling data 131 can be stored on the server 120, customer device 101, provider device 104, or any suitable computing device, which may include a Web-based service.

The map data 127 can define roads and other types of travel paths within a geographic area. The map data 127 can also include topography data and other data that may influence a commute of a user from one location to another. The map data 127 can also include data defining buildings, homes, and other landmarks. The map data 127 can also include image data which may include a satellite image of the roads and paths within a geographic area as well as images of buildings, homes and other landmarks. The map data 127 may be from a number of resources, including a web-based service, government services, or other resources.

The traffic data 124 can include real-time updates on vehicle traffic within a geographic area. The traffic data 124 can also include historical travel data that can be used to predict travel times between two or more locations. The traffic data 124 can be in any suitable format for defining projected travel times between two or more locations that considers a time of travel, weather at a time of travel, traffic at a time of travel, and other factors that may influence a projected travel time. For example, the traffic data 124 can include updates with respect to road closures, delays, construction, new roads, or other scenarios that can impact activity with respect to a calendar event. The traffic data 124 may be from a number of resources, including a web-based service, government services, or other resources.

The weather data 136 can include current, historical, and forecast data indicating weather conditions. The weather data 136 can include data with respect to wind, precipitation, temperature and other conditions that may influence a commute from one location to another. The weather data 136 can be in any suitable format for enabling the projection of travel times between two or more locations. The weather data 136 may be from a number of resources, including a web-based service, government services, or other resources.

The specialty data 126 can include information pertaining to a specialization, subject, topic, one or more industries, or an area of interest. For example, specialty data 126 may include details relating to a medical topic, such as pediatrics, dentistry, etc. In other examples, the specialty data 126 may relate to diseases, cures, conditions, and other like topics. The specialty data 126 can be obtained from a number of different resources including web-based resources such as sites provided by WebMD, American Medical Association, and the Center of Disease Control. These examples are provided for illustrative purposes and are not to be construed as limiting, as the specialty data 126 can be related to any topic or areas of interest.

The workflow data 128 can define a multi-step process and attribute definitions within each step of the process. The workflow data 128 can be obtained from a number of different resources including web-based resources. In addition, the workflow data 128 can be derived from other data such as the specialty data 126. For example, specialty data 126 that pertains to pediatrics can be analyzed to determine a process that involves a number of steps which may include immunization shots, follow-up exams, and other milestones and tasks that are recommended at certain times.

The workload data 132 may include a listing of a number of services, projects, or appointments that are scheduled for a provider. For example, the workload data 132 may list a number of projects that are currently scheduled for a company. The workload data 132 can also be based on scheduling data 131, such as a number of appointments that are scheduled for a doctor. The workload data 131 can also define one or more thresholds. Such data can be used to determine if a company or individual is at, below, or above a given capacity. In some configurations, the workload data 132 defines a value indicating an ability of the individual provider relative to a predetermined workload capacity.

The skill set data 135 identifies and quantifies a range of skills and/or abilities of a particular company or individual. The skill set data 135 may include a hierarchy of data that identifies an industry, specializations within an industry, and details with respect to these specific projects that have been performed in the past. For instance, the skill set data 135 may identify a company as a construction company capable of performing particular types of renovations. The skill set data 135 may also provide details with respect to particular renovation projects and specialized features related to those projects. The skill set data 135 can apply to any company or individual related to any industry.

The work history data 133 can include performance indicators related to a provider 105 or a customer 103. For instance, the work history data 133 can indicate the quality of one or more projects performed by a provider 105. Work history data 133 can include an array of different performance indicators, which may relate to timeliness, productivity, accuracy, price, other indicators and combinations thereof. In other examples, the work history data 133 can indicate performance indicators associated with customers 103. In such examples, a customer 103 can be associated with an array of different performance indicators which may relate to a credit score or any other score associated with the behavior of a company, an individual or a group of individuals.

The payment data 130 can include a record of payments that are made between two or more parties. The payment data 130 can also include data indicating the timeliness in which payments are made. The payment data 130 can include a credit score or any other data that indicates a reliability and/or ability to make timely payments.

The status data 134 can define the availability of one or more parties. For instance, status data 134 can indicate if a party is unavailable, available, or unavailable until a particular date. The status data 134 can also define a level of availability. These examples are provided for illustrative purposes and are not to be construed as limiting. It can be appreciated that the status data 134 include a form of data indicating the availability of a company, an individual or a group of individuals.

The preference data 129 can include customer-defined preferences or provider-defined preferences. In some configurations, the preference data 129 can include a number of weighted parameters that indicate priorities, preferences, and/or goals. For instance, a provider 105 may indicate that they are interested in identifying customers that are timely with respect to appointments. In other examples, a provider 105 may indicate that they are interested in customers having good credit or customers that may have a particular payment history. In some configurations, provider-defined preferences can include a combination of parameters and/or priorities enabling the system 100 to identify, select, and rank customers having a long-term value or a short-term value to a provider. In one illustrative example, provider-defined preferences may identify a number of performance metrics with respect to customers and each performance metric can be weighted to enable a provider 105 to identify customers having a “high lifetime value.” Such preferences can be configured for providers desiring to acquire customers that can benefit their company with respect to long-term goals. The preference data 129 can include provider-defined preferences enabling the system 100 to identify, select, and rank high-volume customers, high-profile customers, and other types of customers or users that fit one or more business models. In addition to identifying preferred customers, the techniques disclosed herein can also enable a provider to “fire,” e.g., terminate a relationship with, unwanted customers.

In some configurations, the preference data 129 can help customers identify and/or terminate providers. In some configurations, customer-defined preferences may indicate they are interested in identifying providers 105 having a particular quality rating. The preference data 129 can also include other data to indicate a combination of parameters, goals, and/or priorities. For instance, the preference data 129 can include customer-defined preferences enabling the system 100 to identify, select, and rank high-volume providers, high-profile providers, and other types of providers that meet the needs of a customer.

The preference data 129 can also define a value indicating a level of “interruptability” of a particular project, job, appointment, or event. As will be described in the examples provided herein, a customer 103 or a provider 105 can indicate if a particular calendar event can be interrupted by other calendar event proposals. Such features enable the techniques disclosed herein to resolve conflicts between calendar events and identify alternative plans if conflicts arise.

It can be appreciated that a level of interruptability, priority or other preferences for a calendar event can be from a number of sources. For instance, a priority or a level of interruptability can be communicated when a calendar event is created. In some configurations, a priority for a calendar event can be based on a priority indicated by a sender of a calendar event. In such an example, a user entering input data can indicate a priority or a level of interruptability. In addition, a priority for a calendar event can be based on a priority established by a recipient of the calendar event. In such an example, a recipient may accept an invitation for an appointment and provide input data indicating a priority and/or a level of interruptability. A priority and/or a level of interruptability can also be a combination of inputs from the sender and recipient of a calendar event.

To enable aspects of the techniques disclosed herein, one or more computing devices of FIG. 1 can be configured to generate data defining one or more insights in response to detecting the presence of a condition. In some configurations, implementations can include receiving scheduling data defining a calendar event. In addition, the implementations can include obtaining contextual data from a plurality of resources. As described in more detail herein, the contextual data can include additional scheduling data, workload data, work history data, payment data, weather data, map data, traffic data, location data and/or other data that relating to a calendar event.

One or more computing devices can be configured to identify a pattern of the contextual data indicating a presence of a condition that affects one or more aspects of a calendar event. A condition can include weather conditions, traffic conditions, the introduction or modification of a calendar event that causes one or more scheduling conflicts, and/or other events or data that can impact aspects of a calendar event. The weather conditions and traffic conditions can include real-time updates or forecasts.

In some configurations, the techniques disclosed herein can identify a pattern of contextual data indicating the presence of the condition that affects the calendar event comprises by generating a value indicating a severity of the condition and identifying the pattern of the contextual data indicating the presence of the condition that affects the calendar event when the value meets or exceeds one or more thresholds or when the pattern of the contextual data meets some criteria.

For example, forecasts with respect to weather conditions and/or traffic conditions that can be used to determine a probability of a commute associated with a calendar event. If the probability meets some criteria or reaches or exceeds one or more thresholds, the system can determine a presence of a condition that affects one or more aspects of the calendar event. In other examples, if two or more appointments overlap to a threshold level or are separated by some threshold amount of time, the system can determine a presence of a condition that affects one or more aspects of a calendar event. For illustrative purposes, a condition that affects one or more aspects of a calendar event can also be referred to herein as a “predetermined condition.”

In response to the detection of a predetermined condition, the techniques disclosed herein can take a number of actions. In some configurations, when the presence of a condition is detected, one or more computers can generate data defining an insight describing aspects of the condition. In addition, one or more computers can generate data defining recommendations and/or resolutions. In some configurations, a plurality of ranked menu items can be generated and displayed in accordance with the techniques disclosed herein.

In some configurations, the presence of a predetermine condition can cause a display of one or more graphical elements indicating the insight on a user interface of one or more computing devices. The insight can include a ranked list of items, wherein individual items of he ranked list of items comprise resolutions configure to cause a generation or a modification of a data object to provide notice of the condition. The data objects can include an email, a calendar event, an instance message, a text, or other data objects configured to communicate information. The resolutions can cause a generation or a modification of a data object to resolve a scheduling conflict. For example, a calendar date and time can be modified based on the contextual data. A new customer or a new provider can be suggested or populated into a field of a calendar event based on the contextual data. In other examples, an insight can cause a generation of one or more graphical elements comprising a text description summarizing the condition, wherein the one or more graphical elements are configured to display the text description on the user interface of the computing device. In some configurations, an insight can cause a generation of one or more graphical elements comprising an image of a map illustrating aspects of the condition.

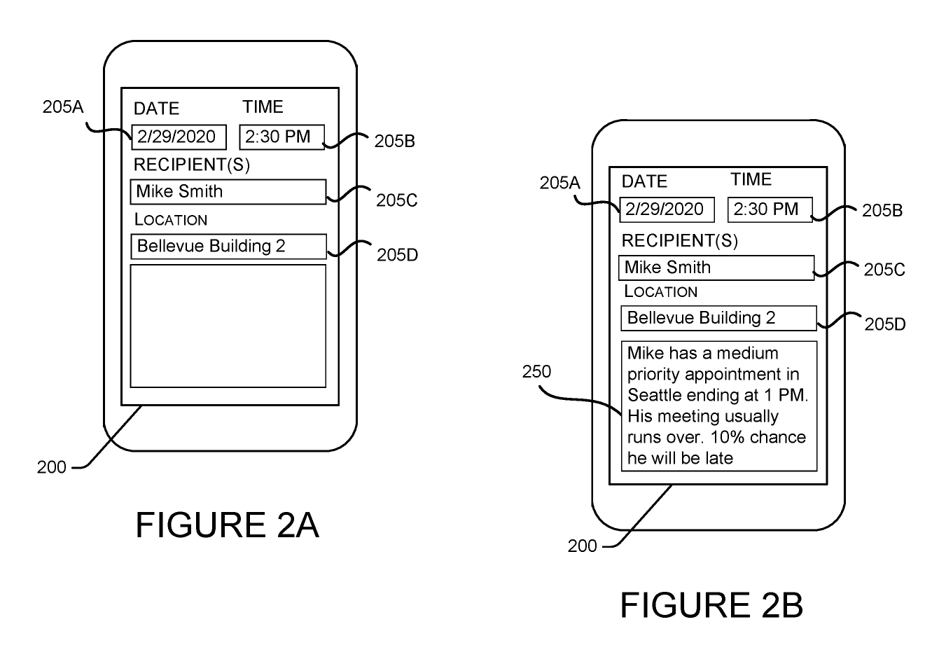

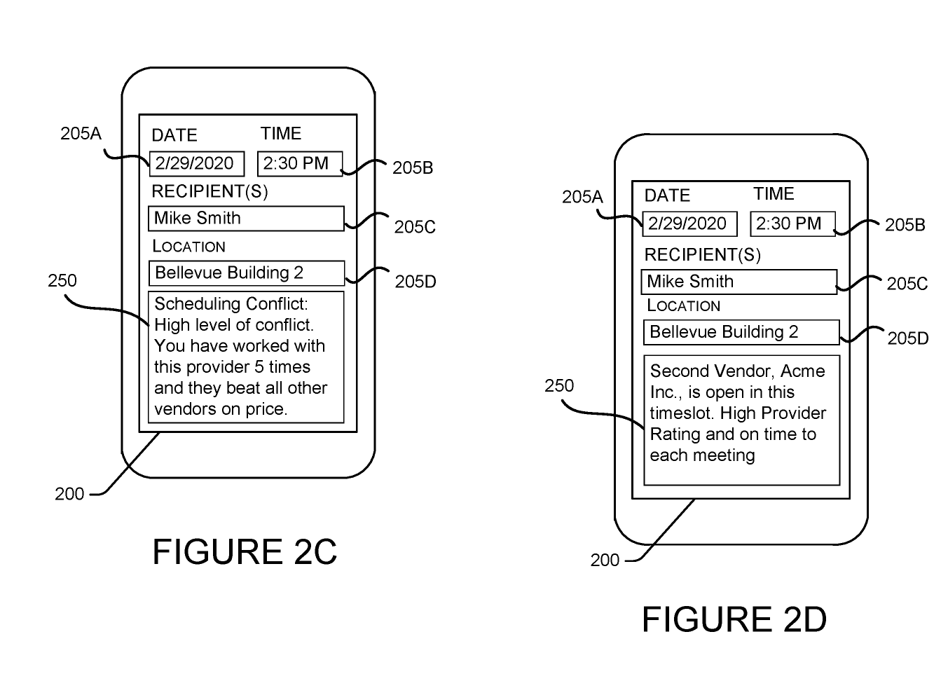

Turning now to FIGS. 2A-2D, an example graphical user interface (UI) is configured to display and receive data relating to the techniques disclosed herein. The example UI can be displayed to a user desiring to schedule a calendar event or otherwise provide input data. Although the following examples include project-related or calendar-related interfaces, it can be appreciated that techniques disclosed herein can be applied to any user interface configured to take any suitable form of input, including voice commands, gestures, etc. It can also be appreciated that the examples disclosed herein can apply to any type of user, e.g., a customer 103 or a provider 105.

FIG. 2A is a screen diagram showing an illustrative graphical UI 200 that displays data relating to techniques for providing contextually-aware insights into calendar events. The UI 200 can be generated by client module 102, shown in FIG. 1, and presented on a computing device, such as a customer device 101 or a provider device 104.

As illustrated in FIG. 2A, the UI 200 includes a display of a number of graphical elements for receiving and displaying input data. In this example, the UI 200 includes a “date” UI element 205A for receiving a preferred appointment date, a “time” UI element 205B for receiving a preferred appointment time, a “recipient” UI element 205C for receiving data specifying a name of at least one provider 105, a “location” UI element 205D for receiving data specifying a location associated with the appointment. The location related to the appointment can include, for example, a room number, an address, a street, city, state, or any other information indicating a location associated with the appointment. The example of FIG. 2A is provided for illustrative purposes and is not to be construed as limiting. It can be appreciated that the input data can be in other forms, such as a text description indicating an interest to initiate a project, schedule a series of meeting, etc. The input data can be in any format, e.g., a text message, an email, or an audio file, or any format suitable for initiating a calendar event.

In response to receiving the input data, contextual data can be from a number of resources can be analyzed to determine one or more insights. The contextual data can include traffic data 124, location data 125, specialty data 126, map data 127, workflow data 128, preference data 129, payment data 130, scheduling data 131, workload data 132, work history data 133, status data 134, skill set data 135, weather data 136, and other data. The contextual data can also include received from one or more resources.

In some configurations, the techniques disclosed herein can analyze aspects of calendar events and other data to determine a location associated with a given calendar event and locations associated with calendar events preceding and following the given calendar event. In the example of FIG. 2A, the given calendar event has a location noted in “Bellevue Building 2.” For illustrative purposes, it is a given that the recipient, Mike Smith, has a prior appointment from noon until 1 PM that is located in Seattle. In addition, other scheduling data 131 and location data 125 associated with Mike shows that a similar meeting typically runs over and that he leaves such meetings 10 minutes after the scheduled ending time. For instance, GPS information can show his movements relative to an appointment. Such data and other contextual data, such as traffic data and weather data, can be analyzed to determine if a probability of a commute between the current calendar event and a preceding calendar event. In some configurations, the probability of the commute and other factors, such as a priority and/or an interruptability of a calendar event, can be utilized to determine a severity of a conflict between the two meetings. In this example, the contextual information is analyzed to generate data defining an insight. An insight may provide a text description of the conflict, an image or illustration of the conflict, a voice description of the conflict, a description of the probability of the commute, a description of a severity level, etc.

FIG. 2B illustrates one sample of an insight generated as a result of the current calendar event created by the input data. In this example, a graphical element 250 includes a text description indicating a number of salient insights. In this example, the insight describes a priority, time, and location of the prior appointment. The insight also describes a historical view associated with the prior appointment. In addition, the insight shows a value indicating a probability of a commute to the current calendar event.

Such an insight can be based on one or more thresholds, e.g., a probability of a commute may be displayed if the probability falls below a predetermined level. Other conditions may trigger the display of an insight, such as a discrepancy between a calendar event and a user's location data, in this example, since location data associated with Mike shows he typically leaves a meeting 10 minutes after a conclusion of a meeting, a system may select data indicating such a pattern for display as an insight. In this example, the insight indicates that “Mike has a medium priority appointment in Seattle ending at 1 PM. His meeting usually runs over. 10% chance he will be late.”

Preference data can be utilized to control the type of insights that are displayed to a user. For instance, an insight can help a customer identify a preferred provider, or an insight can help a provider identify a preferred customer. In the example shown in FIG. 2C, the displayed insights are based on work history data of several providers. In this example, the recipient of the calendar event is a service provider.

For illustrative purposes, it is a given that the selected time and date presents a scheduling conflict. Thus, in this example, in response to the detection of the conflict, the graphical element 250 includes an insight indicating the conflict. In this example, it is a given that the two calendar events that conflict with one another are high priority calendar events. The graphical element 250 also includes an indication of the priority. In addition, the graphical element 250 also includes an indication of a work history between the user and the recipient of the calendar event. In this example, the insight includes a summary indicating a number of times they have worked together, and a price comparison between the selected provider and other providers. A displayed insight based on scheduling data 131, work history data 133, payment data 130, and other data, can be useful for a user in making decisions to resolve the conflict.

In the example shown in FIG. 2D, other types of insights are shown. In this example, it is a given that preference data indicates that a customer prefers to work with providers that are timely and have a high performance rating. Based on such preference data, performance data associated with the provider indicated in the input data may be summarized as an insight. In this example, the graphical element 250 includes an insight describing a recommendation for a preferred provider, and information describing the availability of the preferred provider. In addition, a summary of the performance data is provided.

These examples are provided for illustrative purposes and are not to be construed as limiting. Although these examples show a customer looking for a vendor, the techniques disclosed herein enable customers to identify providers with respect to one or more goals, and at the same time, providers can identify customers with respect to one or more goals. For example, performance data can quantify a quality level with respect to a provider's work product. At the same time, performance data can quantify a customer's payment history or credit rating. If a particular performance rating of a customer or a provider falls below a threshold, the techniques disclosed herein may generate and display insights to a customer or a provider.

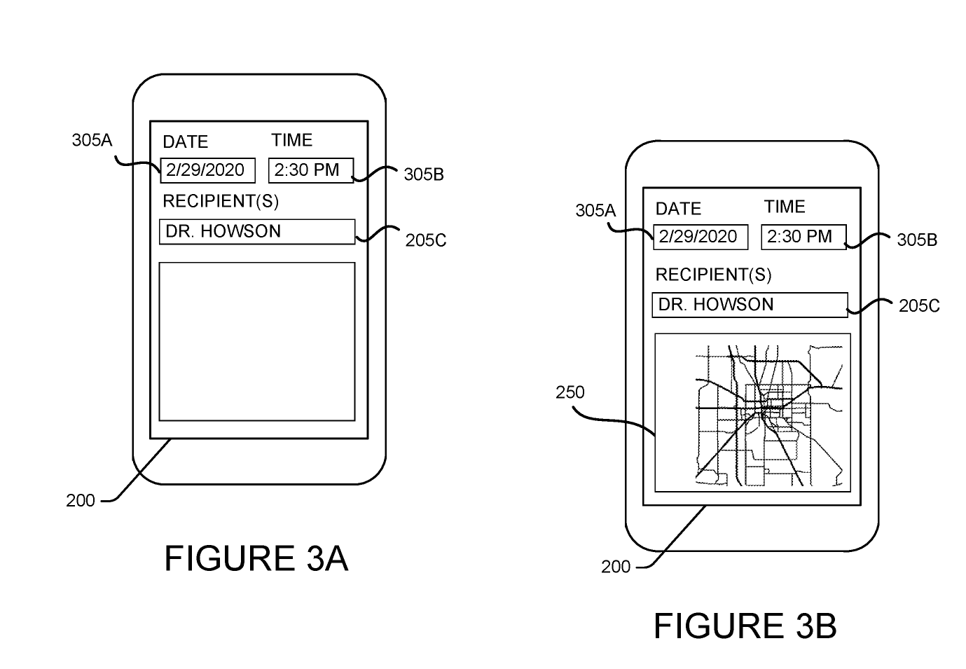

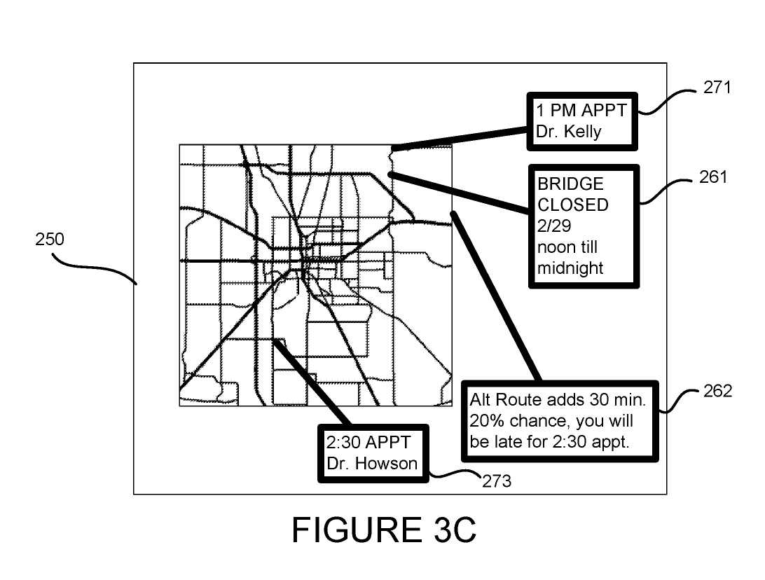

Now turning to FIGS. 3A-3C, an illustrative example of an insight that includes map data and other data is shown and described. Similar to the example described above, the example UI of FIGS. 3A-3C can be displayed to a user desiring to schedule a calendar event. As will be described in detail below, various insights that are based on traffic data, map data, scheduling data, and other data can be used to provide insights in response to the receipt of input data.

As illustrated in FIG. 3A, the UI 300 includes a display of a number of graphical elements for receiving and displaying input data. In this example, the UI 200 includes a “date” UI element 305A for receiving a preferred appointment date, a “time” UI element 305B for receiving a preferred appointment time, a “recipient” UI element 305C for receiving data specifying a name of at least one provider 105. The example of FIG. 3A is provided for illustrative purposes and is not to be construed as limiting. It can be appreciated that the input data can be in other forms, such as a text description indicating an interest to initiate a project, schedule a series of meeting, etc. The input data can be in any format, e.g., a text message, an email, or an audio file, or any format suitable for initiating a calendar event.

In response to receiving the input data, contextual data from a number of resources can be analyzed to determine a presence of a condition and/or to generate one or more insights. The contextual data can include traffic data 124, location data 125, specialty data 126, map data 127, workflow data 128, preference data 129, payment data 130, scheduling data 131, workload data 132, work history data 133, status data 134, skill set data 135, weather data 136, and other data. The contextual information may be obtained from a number of resources, for instance, location data associated with the provider, Dr. Howson, can be obtained from a website, address book, calendaring system, etc. The location data associated with the provider, Dr. Howson, can include, for example, a room number, an address, a street, city, state, or any other information indicating a location associated with the appointment.

The contextual data is analyzed to generate an insight with respect to calendar events preceding the calendar event defined by the input data. In this example, location data of the customer and the provider can be utilized to determine a travel route associated with the calendar event. In addition, traffic data and other data can identify conditions that can affect one or more determined travel routes. This example, for illustrative purposes, it is given that the traffic data indicates a road closure on at least one determine travel route.

FIG. 3C illustrates a close-up view of the graphical element 250 illustrating an insight containing map data and generated text descriptions of one or more conflicts. In this example, the insight includes a first graphical element 271 that includes text descriptions of content data from a previous appointment, a 1 PM appointment with Dr. Kelly. This example also includes a second graphical element 273 that includes content data from the current appointment, the 2:30 appointment with Dr. Howson. Also, this example insight also includes a graphical element 261 having a text description of a condition that affects at least one travel route. In this example, the traffic data indicates that a bridge is closed at the time of the appointment, and the graphical element includes a summary of such data. In addition, this example insight includes another graphical element 262 having a text description describing an alternative route. The text description may illustrate a time that is needed for the alternative route, and a value indicating a probability of a successful commute between the appointments.

The techniques disclosed herein may utilize any suitable technology for determining a probability of a successful commute and for determining one or more travel routes between two or more locations. These examples are provided for illustrative purposes and are not to be construed as limiting. It can be appreciated that any information affecting the calendar events may be displayed as an insight in a graphical element.

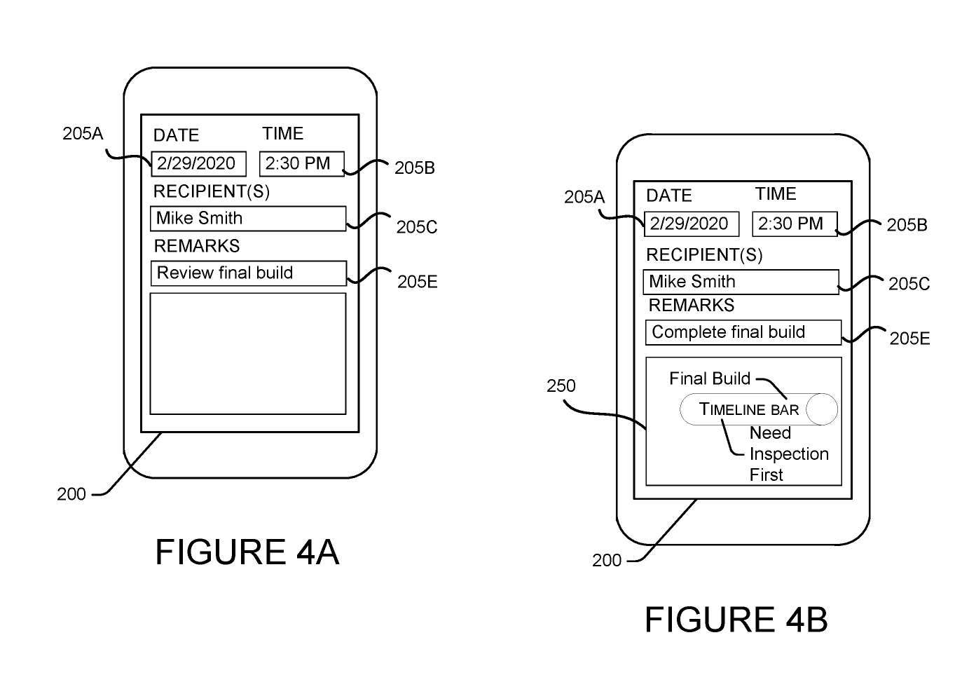

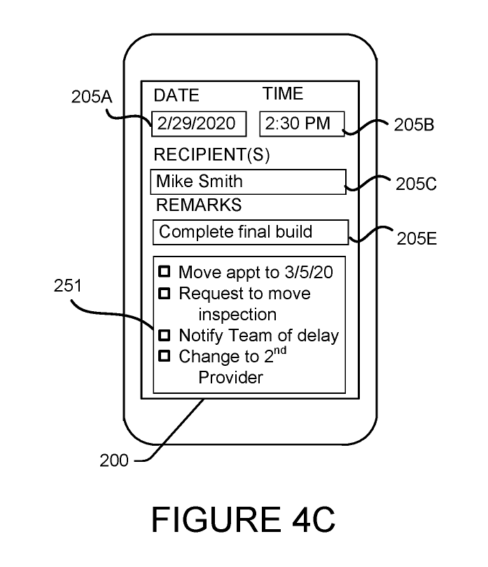

As summarized above, other types of contextual data can be analyzed to generate an insight. In the example shown in FIGS. 4A-4C, workflow data is analyzed to determine if a particular calendar event is consistent with a workflow or process. In this example, as shown in FIG. 4A, the input data defines a calendar event for finalizing an aspect of a project. By the retrieval of contextual information, which may include workflow data and other data, the techniques disclosed herein can analyze the contents of the input data with workflow data and other contextual data to determine if the contents of the input data are consistent with the workflow.

Consider the following scenario where a finalization of a construction project requires an inspection. Based on an analysis of workflow data and scheduling data, in this example, the techniques disclosed herein can identify a conflict, wherein the calendar event is set to finalize a project before an inspection. If one or more rules defined by workflow data, which may be derived from specialty data, indicate a conflict between the finalization of a project and an inspection, the techniques disclosed herein can generate data defining an insight to such a conflict. In this example, the data defining the insight can include a graphical representation of a workflow, one or more indicators of the relevant calendar events, and text describing the conflict. In the example shown in FIG. 4B, the text description indicates the presence of a conflict and a description of the conflict. As also shown, a graphical element may also be configured to show a conflict relative to a timeline.

In addition to providing insights, the techniques disclosed herein can provide one or more recommendations and/or resolutions. In one example, the techniques disclosed herein can analyze contextual data from a number of resources to generate data objects which may include a modified calendar event, a new calendar event, an email, or other form of communication for resolving the conflict. In some configurations, an insight may include a ranked list of menu items presenting different recommendations related to a detected condition. A recommendation may include a recommendation for a new time, a new provider, a new customer, a new process, and/or any other recommendation to resolve a discovered conflict.

FIG. 4C illustrates an example of a graphical element including a ranked list of resolutions. In this example, the ranked list of resolutions includes a recommendation to move the appointment to a new date, a recommendation requesting to move the inspection, the recommendation to provide notice of the conflict, and a recommendation to change a provider. These examples are provided for illustrative purposes and are not to be construed as limiting.

Any number of recommendations may be generated, which may include an email to provide notice to one or more parties, a new or modified calendar event, or other resolutions. Individual recommendations can be based on one or more goals defined in preference data. For example, if a provider or customer has certain goals, performance data associated with subcontractors can be evaluated to select alternative subcontractors that meet one or more goals defined in the preference data. The recommendations can include new proposed dates based on the availability and/or interruptability of one or more entities. The recommendations may be ranked based on the eligibility of a provider or a customer, a priority with respect to an event, and other criteria defined in contextual data received by the system 100.

In some configurations, a recommended date and time, e.g., a timeslot, can be based on the availability of one or more parties involved, such as a provider or a customer. The date and time of the recommendation can also be based on location information, map data and other information that enables the customer and/or the provider to successfully commute to an appointment. As will be described in more detail below, the use of preference data and other data can be used to identify and/or rank a recommended timeslot. In addition to generating recommendations for a timeslot, the techniques disclosed herein can also include the selection of one or more providers.

The selection and/or ranking of a candidate providers and/or candidate timeslots can be based on a number of factors. In some configurations, the analysis of scheduling data 131 can influence a selection or ranking of one or more providers. For instance, the techniques disclosed herein can identify one or more providers that is available at a date and time indicated in the input data. If one or more providers are available during the desired date and time, such providers may be selected and/or ranked in the ranked list of providers. A provider having an open schedule may be ranked higher than a provider having a conflict.

In addition, a severity of a conflict may influence the ranking of a candidate provider and/or candidate timeslot. In some configurations, the techniques disclosed herein can cause the generation of data indicating a severity of a conflict. Such a quantification can be based on a number of factors, including scheduling data of two or more entities, a probability of a commute between two or more appointments, and other factors that can be used to determine that a meeting is improbable or probable. Data indicating a severity of a conflict can also be based on factors indicating that scheduling conflict is irreconcilable or reconcilable. Data indicating a severity of a conflict can also be based on a priority or a degree of interruptability with respect to a particular calendar event. For instance, if two meetings are determined to have a high degree of interruptability, a severity of such a conflict can be higher than a conflict where only one calendar event has a high degree of interruptability.

In one example, scheduling data 131 associated with one or more providers 105 and customers 103 can be analyzed to determine if there are scheduling conflicts. The ranking of a candidate provider and/or candidate timeslot can also be influenced by a severity of a scheduling conflict. For instance, if a first provider has a scheduling conflict that completely overlaps with an appointment defined by the input data, the ranking of the first provider may be lower than another provider having a scheduling conflict that does not completely overlap with the appointment defined by the input data. A candidate provider and/or candidate timeslot that is associated with a highly severe conflict can be ranked lower than a candidate provider and/or candidate timeslot associated with a less severe conflict.

In some configurations, a conflict or a condition associated with a calendar event may be based on an alignment between specialty data, skill set data, and other data associated with the calendar event. For instance, if a calendar event indicates a need for a dishwasher repair expert, and skill set data associated with a selected provider indicates that the provider's skill set does not align with a described task or need, the system 100 may detect a conflict, e.g., a presence of a condition that requires an action. The severity of a conflict can also be based on values quantifying an alignment between the skill set data and requirements associated with a calendar event. For example, if a calendar event indicates a need for an ear, nose and throat specialist, and the calendar event indicates an appointment with a general practitioner, one or more values may be generated to quantify this alignment, values which may be a factor in determining a severity of a conflict. The ranking of a recommended provider and/or a recommended timeslot can be adjusted based on data defining the severity of the conflict.

In some configurations, the analysis of location data 125, map data 127, weather data 136, and/or traffic data 124 can influence a selection and/or ranking of a candidate provider and/or candidate timeslot. For instance, a first provider may be ranked higher than a second provider if the first provider involves a shorter commute versus the second provider. Such an analysis may also involve map data, weather data, and other data to determine projections of commute times, a probability of a commute, and/or a degree of difficulty of a commute.

In some configurations, the analysis of location data 125 and scheduling data 131 can influence a selection and/or ranking of a candidate provider and/or candidate timeslot. For instance, if a particular provider has two calendar events that are adjacent to one another, a probability of a successful commute between the events can be determined. A provider having a high probability of a successful commute can be ranked higher than a provider having a low probability of a successful commute.

Such an analysis can apply to the commute of the customer. For instance, if a consumer has two appointments that are adjacent to one another, a probability associated with the consumer's commute between the appointments can influence the selection and/or ranking of one or more providers. For example, if the user scheduling data 131 indicates that the consumer only has 20 minutes to commute to the location of a particular provider, the map data 127, traffic data 124, and other contextual data can be analyzed to determine if that commute is possible within the given timeframe. A probability may be generated for a commute to each provider, and each provider may be ranked based on such generated data. In addition, one or more providers may be filtered from the list if the probability does not meet or exceed one or more thresholds, such as one or more performance thresholds.

The ranked list of recommendations can also be based on the map data 127, traffic data 124, location data 125, weather data 136 and/or other data. In such configurations, traffic data 124 can indicate traffic conditions at the desired date and time indicated in the input data. In such configurations, one or more devices and/or the server 120 can generate projections to determine if a user or provider can make an appointment based on traffic patterns. For instance, if the appointment is scheduled for a weekday during rush hour, the techniques disclosed herein can change the ranking of a particular provider if a commute associated with that provider is impacted by such traffic conditions. Such an analysis can be influenced by a forecast defined in weather data 136. For example, if weather data 136 indicates a favorable forecast, the ranking of providers impacted by such a forecast can increase. In addition, if weather data 136 indicates an unfavorable forecast, the ranking of providers impacted by such a forecast can decrease.

In some configurations, the analysis of work history data 133, skill set data 135, workflow data 128, workload data 132 and/or other contextual data can influence a selection and/or ranking of a candidate provider and/or candidate timeslot. For instance, a particular provider having a high quality rating may be ranked higher than a provider having a low quality rating. In another example, the skill set 135 can be analyzed to determine if an ability of a provider aligns with goals associated with a particular appointment. Data quantifying an alignment between the skill set of a provider with one or more goals can influence the ranking of that provider and/or other providers.

In another example, a provider having a heavier workload can be ranked higher or lower than a provider having a lighter workload. In yet another example, workflow data 128 can be analyzed to determine the ranking of a particular provider. For instance, workflow data 128 defining a multistep process indicates that a particular provider is more suitable for a particular step, the ranking of such a provider maybe higher than a provider that is less suitable for that particular step. These examples are provided for illustrative purposes and are not to be construed as limiting.

In some configurations, work history data 133 can define the status of a relationship between two or more entities. For instance, if two or more entities are currently working on a project, a ranking with respect to a customer and/or a provider may be increased. If the two or more parties have not worked together for some time, a ranking with respect to a customer and or a provider may be increased or decreased depending on a desired outcome. For instance, if a customer having a high lifetime value, such as Bill Gates' family, desires to set an appointment with a provider, such providers seeking such customers/patients may be ranked higher than other providers. In another example, if preference data of a patient indicates a desire to work with a doctor or other provider having a certain status, e.g., a top 10 specialist, such providers matching customer goals can be ranked higher than other providers that do not match the goals.

In some configurations, a ranking and/or selection of a provider can be based on payment history data. For example, if payments of a customer are regularly made on time, the ranking of a provider desiring such customers may be increased. In some configurations, preference data may define a threshold for a provider. If performance data associated with a customer falls below a threshold, e.g., with respect to payments, communication, and/or complaints, the techniques disclosed herein can cause the generation of data providing notice that a customer relationship should be terminated. Other data providing notice of reminders can be generated in response to one more conditions, such as a late payment, a history of late payments, complaints, etc. In such configurations, emails, meeting notifications or other forms of data objects can be generated when such conditions are discovered by the system.

Returning to the example of FIG. 4C, the graphical element 251 illustrates a number of candidate providers, candidate timeslots, and other recommendations. The graphical element 251 can be configured to receive a selection, such as a user selection, of at least one item of the ranked list. A selection of at least one item can cause the generation or modification of a calendar event, which can be communicated to a number of users for verification and processing. Scheduling data defining the calendar event can be stored in one or more devices and/or servers. In addition, notifications, reminders and other forms of communication can be generated based on such scheduling data.

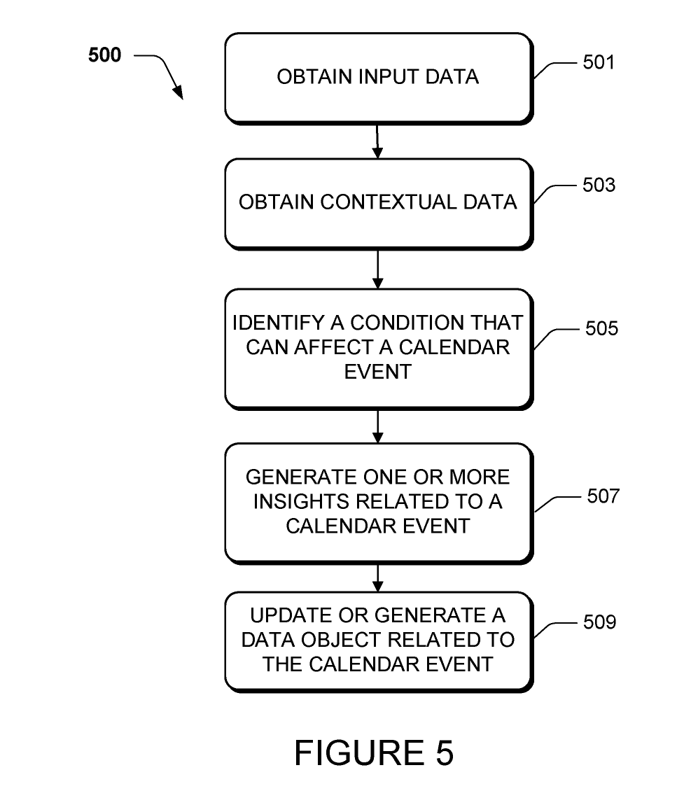

Turning now to FIG. 5, aspects of a routine 500 for providing contextually-aware insights into calendar events are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As will be described in more detail below, in conjunction with FIG. 1 and FIG. 5, the operations of the routine 500 are described herein as being implemented, at least in part, by an application, component, and/or circuit. Although the following illustration refers to the components of FIG. 1, it can be appreciated that the operations of the routine 500 may be also implemented in many other ways. For example, the routine 500 may be implemented, at least in part, by computer processor or processor of another computer. In addition, one or more of the operations of the routine 500 may alternatively or additionally be implemented, at least in part, by a computer working alone or in conjunction with other software modules, such as the server module 121.

With reference to FIG. 5, the routine 500 begins at operation 501, where one or more computing devices obtain input data. The input data can include a voice input, a text input, a selection of a menu item, or other types of input where an action is initiated by, or data is received from, a user or a computing device. For example, a user can say or type information into an email or a calendar event describing a topic, area of interest, project or an event. In other examples, a user can provide other forms of input data, such as a text description or a voice input indicating a service category, e.g., “I need to build an appointment to repair my car,” or “I need to make an appointment for a doctor.”

In operation 503, the one or more computing devices obtain contextual data. As described herein, the contextual data can be obtained from a number of different resources. For example, contextual data can be obtained from a traffic data resource 106A, map data resource 106B, search engine resource 106C, specialty data resource 106D, and a weather data resource 106E, and/or other resources suitable for storing, processing, and/or communicating contextual data.

The contextual data can be related to service providers and/or consumers. The contextual can include, for example, data defining a prior work history between two or more entities, payment histories, credit histories, an availability of one or more parties, a location of a project, travel time to an appointment, traffic data, skill set data, preferred business hours, scheduling availability, performance metrics, scheduling conflicts, customer preferences, vendor preferences, workflow definitions, other data, and combinations thereof. The techniques disclosed herein can also quantify a value of a customer or a value of a vendor. Such contextual data can be received from one or more resources or such contextual data can be derived from other types of contextual data. For instance, data defining a lifetime value of a customer or a lifetime value of a provider can be generated from payment histories, credit histories, and other information.

The contextual data can also include specialty data 126 pertaining to a specialization, subject, topic, one or more industries, or an area of interest. For example, specialty data 126 may include details relating to a medical topic, such as pediatrics, dentistry, etc. In other examples, the specialty data 126 may relate to diseases, cures, conditions, and other like topics. These examples are provided for illustrative purposes and are not to be construed as limiting, as the specialty data 126 can be related to any topic or areas of interest. As summarized above, such contextual data can be utilized for selecting and ranking a recommendation item, which may involve aligning a provider and a customer based on a customer's needs and a providers ability to work with a particular topic or industry.

Next, in operation 505, one or more computing devices can identify the presence of a predetermined condition. A predetermined condition may be detected at the time an appointment is made or at a later time when contextual data indicates a change in one or more conditions. In some configurations, one or more computing devices can monitor contextual data related to one or more calendar events. Based on one or more patterns of the contextual data, if a predetermined condition is detected, the techniques disclosed herein may generate data describing an insight to the detected conditions.

For example, a system can analyze two or more calendar events to determine the presence of a conflict. In one illustrative example, a conflict may arise if two calendar events overlap one another. In other examples, two or more calendar events may create a conflict based on a number of other factors, which may be influenced by weather, traffic, road closures, and conditions presented in received contextual data, such as performance data, location data, and other data.

Next, in operation 507, one or more computing devices can generate data defining an insight related to a calendar event or a detected condition. An insight can include a text description, an image, a graphical indicator, a generated voice, and/or any combination of data objects suitable for communicating useful information regarding one or more calendar events. For example, an insight can provide salient facts regarding the nature of a scheduling conflict, preferences of one or more users, an update to one or more calendar events, and/or updates to conditions that can affect one or more calendar events. Data defining one or more insights related to the conditions can be communicated to computers and/or users in many different ways, including but not limited to, emails, notifications, reminders, appointments, modifications to appointments etc.

Next, at operation 509, one or more computing devices can generate or update a data object related to a calendar event. For example, one or more computing devices can modify a calendar event to include a new provider, customer, or a new time to resolve a conflict. In another example, one or more computing devices can generate an email message to provide notice of a detected condition, such as a scheduling conflict created by a changed environment. A notification can be a one-time event or a recurring event. For instance, if a scheduling conflict is discovered, one or more computing devices can generate and deliver a reminder to a user of such a conflict once every few days until the conflict is resolved.

Operation 509 can also include the presentation of one or more resolutions to a detected condition. In one example, a resolution may include the generation and presentation of a ranked list of items based on the input data and/or the obtained contextual data. The ranked list of items can be automatically generated, or the ranked list of items can be generated in response to one or more actions. In one example, criteria defined in user preference data can indicate one or more thresholds for generating a ranked list of items. The contextual data can be analyzed to determine the presence of a condition that meets or exceeds the one or more thresholds. When such conditions are discovered, one or more computing devices can generate the ranked list of items. An example of a ranked list of items is described above and shown in FIG. 4C.

In another example, a ranked list of items can be generated in response to a user action. For example, when a user provides input data defining a calendar item, the input data and the contextual data can be processed by the use of the techniques described herein to generate a ranked list of items. It can be appreciated that a ranked list may also include tasks, such as a reminder to schedule an appointment, an automatically generated email message, an automatically generated text message, or the generation of other data such as workflow data. In some configurations, the ranked list may be displayed in proximity to the input data and/or a graphical element indicating an insight. Configurations enable users or computers to select items of the ranked list.

One or more computing devices can generate a calendar event or another type of data object in response to a selection of an item on the ranked list. A selection of at least one item can be achieved by a number of different methods. For instance, operation 509 can involve a user input indicating a selection of an item. In other examples, operation 509 can involve techniques for an automatic selection of one or more items. In such configurations, preference data can define criteria for an automatic selection of one or more items. For instance, if an item is associated with performance data that meets the threshold defined in preference data of a provider or a consumer, such items can be automatically selected by the one or more computing devices. Operation 509 can also include the communication and processing of any type of data object in response to a selection of an item. For instance, reminders, notifications, emails, and other data objects may be sent to a provider and/or customer.

FIG. 6 shows additional details of an example computer architecture 600 for a computer, such as the computing device 101 (FIG. 1), capable of executing the program components described herein. Thus, the computer architecture 600 illustrated in FIG. 6 illustrates an architecture for a server computer, mobile phone, a PDA, a smart phone, a desktop computer, a netbook computer, a tablet computer, and/or a laptop computer. The computer architecture 600 may be utilized to execute any aspects of the software components presented herein.

The computer architecture 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing an operating system 607, data, such as the contextual data 650, input data 651, scheduling data 131, calendar event 667, content data 669, and one or more application programs.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes the claims, the phrase “computer storage medium,” “computer-readable storage medium” and variations thereof, does not include waves, signals, and/or other transitory and/or intangible communication media, per se.

According to various configurations, the computer architecture 600 may operate in a networked environment using logical connections to remote computers through the network 756 and/or another network (not shown). The computer architecture 600 may connect to the network 756 through a network interface unit 614 connected to the bus 610. It should be appreciated that the network interface unit 614 also may be utilized to connect to other types of networks and remote computer systems. The computer architecture 600 also may include an input/output controller 616 for receiving and processing input from a number of other devices, including a keyboard, mouse, or electronic stylus (not shown in FIG. 6). Similarly, the input/output controller 616 may provide output to a display screen, a printer, or other type of output device (also not shown in FIG. 6).

It should be appreciated that the software components described herein may, when loaded into the CPU 602 and executed, transform the CPU 602 and the overall computer architecture 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 may include other types of computing devices, including hand-held computers, embedded computer systems, personal digital assistants, and other types of computing devices known to those skilled in the art. It is also contemplated that the computer architecture 600 may not include all of the components shown in FIG. 6, may include other components that are not explicitly shown in FIG. 6, or may utilize an architecture completely different than that shown in FIG. 6.

FIG. 7 depicts an illustrative distributed computing environment 700 capable of executing the software components described herein for providing contextually-aware insights into calendar events. Thus, the distributed computing environment 700 illustrated in FIG. 7 can be utilized to execute any aspects of the software components presented herein. For example, the distributed computing environment 700 can be utilized to execute aspects of the software components described herein.

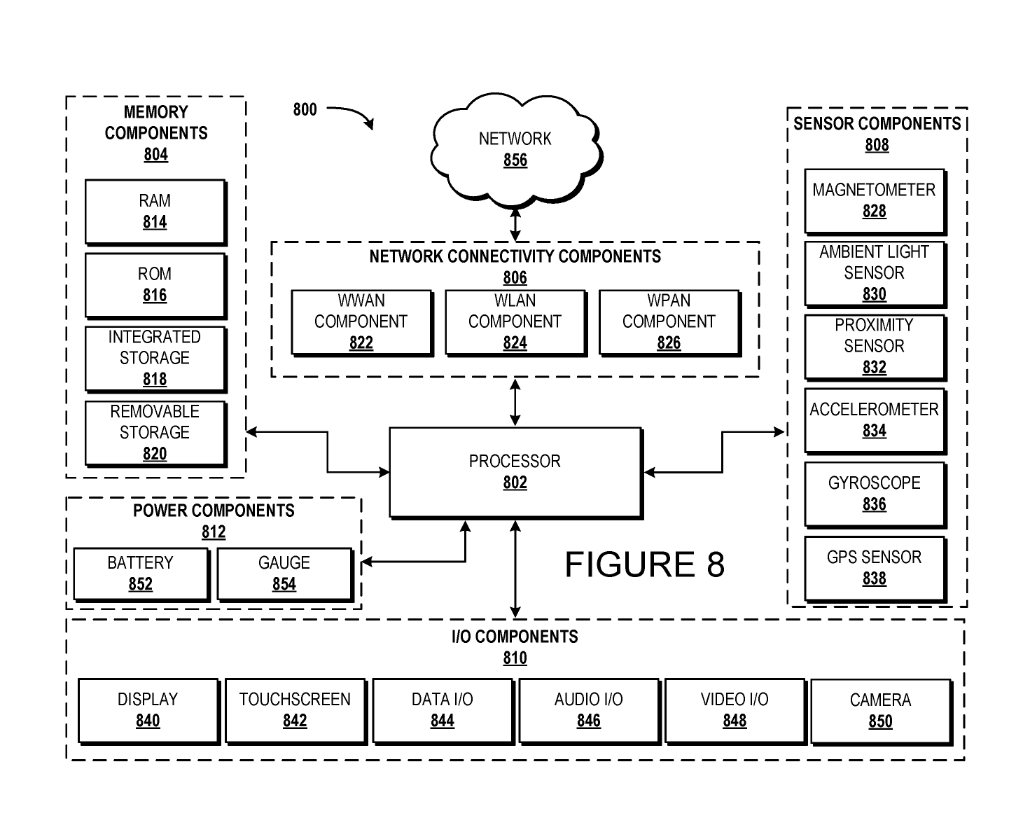

According to various implementations, the distributed computing environment 700 includes a computing environment 702 operating on, in communication with, or as part of the network 704. The network 704 may be or may include the network 756, described above. The network 704 also can include various access networks. One or more client devices 706A-706N (hereinafter referred to collectively and/or generically as “clients 706”) can communicate with the computing environment 702 via the network 704 and/or other connections (not illustrated in FIG. 7). In one illustrated configuration, the clients 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of clients 706 can communicate with the computing environment 702. Two example computing architectures for the clients 606 are illustrated and described herein with reference to FIGS. 6 and 8. It should be understood that the illustrated clients 706 and computing architectures illustrated and described herein are illustrative, and should not be construed as being limited in any way.

In the illustrated configuration, the computing environment 702 includes application servers 708, data storage 710, and one or more network interfaces 712. According to various implementations, the functionality of the application servers 708 can be provided by one or more server computers that are executing as part of, or in communication with, the network 704. The application servers 708 can host various services, virtual machines, portals, and/or other resources. In the illustrated configuration, the application servers 708 host one or more virtual machines 714 for hosting applications or other functionality. According to various implementations, the virtual machines 714 host one or more applications and/or software modules for providing contextually-aware insights into calendar events. It should be understood that this configuration is illustrative, and should not be construed as being limiting in any way. The application servers 708 also host or provide access to one or more portals, link pages, Web sites, and/or other information (“Web portals”) 716.

According to various implementations, the application servers 708 also include one or more mailbox services 718 and one or more messaging services 720. The mailbox services 718 can include electronic mail (“email”) services. The mailbox services 718 also can include various personal information management (“PIM”) services including, but not limited to, calendar services, contact management services, collaboration services, and/or other services. The messaging services 720 can include, but are not limited to, instant messaging services, chat services, forum services, and/or other communication services.

The application servers 708 also may include one or more social networking services 722. The social networking services 722 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 722 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 722 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 722 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 722 are not mentioned herein for the sake of brevity. As such, the above configurations are illustrative, and should not be construed as being limited in any way. According to various implementations, the social networking services 722 may host one or more applications and/or software modules for providing the functionality described herein for providing contextually-aware insights into calendar events. For instance, any one of the application servers 708 may communicate or facilitate the functionality and features described herein. For instance, a social networking application, mail client, messaging client or a browser running on a phone or any other client 706 may communicate with a networking service 722 and facilitate the functionality, even in part, described above with respect to FIG. 5.

As shown in FIG. 7, the application servers 708 also can host other services, applications, portals, and/or other resources (“other resources”) 724. The other resources 724 can include, but are not limited to, document sharing, rendering or any other functionality. It thus can be appreciated that the computing environment 702 can provide integration of the concepts and technologies disclosed herein provided herein with various mailbox, messaging, social networking, and/or other services or resources.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more server computers configured to host data for the computing environment 702. The data storage 710 can include, host, or provide one or more real or virtual data stores 726A-726N (hereinafter referred to collectively and/or generically as “datastores 726”). The datastores 726 are configured to host data used or created by the application servers 708 and/or other data. Although not illustrated in FIG. 7, the datastores 726 also can host or store web page documents, word documents, presentation documents, data structures, algorithms for execution by a recommendation engine, and/or other data utilized by any application program or another module. Aspects of the datastores 726 may be associated with a service for storing files.

The computing environment 702 can communicate with, or be accessed by, the network interfaces 712. The network interfaces 712 can include various types of network hardware and software for supporting communications between two or more computing devices including, but not limited to, the clients 706 and the application servers 708. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the clients 706. It should be understood that the clients 706 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 700 to utilize the functionality described herein for providing contextually-aware insights into calendar events, among other aspects.

Turning now to FIG. 8, an illustrative computing device architecture 800 for a computing device that is capable of executing various software components described herein for providing contextually-aware insights into calendar events. The computing device architecture 800 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. The computing device architecture 800 is applicable to any of the clients 706 shown in FIG. 7. Moreover, aspects of the computing device architecture 800 may be applicable to traditional desktop computers, portable computers (e.g., laptops, notebooks, ultra-portables, and netbooks), server computers, and other computer systems, such as described herein with reference to FIG. 5. For example, the single touch and multi-touch aspects disclosed herein below may be applied to desktop computers that utilize a touchscreen or some other touch-enabled device, such as a touch-enabled track pad or touch-enabled mouse.

The computing device architecture 800 illustrated in FIG. 8 includes a processor 802, memory components 804, network connectivity components 806, sensor components 808, input/output components 810, and power components 812. In the illustrated configuration, the processor 802 is in communication with the memory components 804, the network connectivity components 806, the sensor components 808, the input/output (“I/O”) components 810, and the power components 812. Although no connections are shown between the individuals components illustrated in FIG. 8, the components can interact to carry out device functions. In some configurations, the components are arranged so as to communicate via one or more busses (not shown).

The processor 802 includes a central processing unit (“CPU”) configured to process data, execute computer-executable instructions of one or more application programs, and communicate with other components of the computing device architecture 800 in order to perform various functionality described herein. The processor 802 may be utilized to execute aspects of the software components presented herein and, particularly, those that utilize, at least in part, a touch-enabled input.

In some configurations, the processor 802 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 802 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 802 is, or is included in, a system-on-chip (“SoC”) along with one or more of the other components described herein below. For example, the SoC may include the processor 802, a GPU, one or more of the network connectivity components 806, and one or more of the sensor components 808. In some configurations, the processor 802 is fabricated, in part, utilizing a package-on-package (“PoP”) integrated circuit packaging technique. The processor 802 may be a single core or multi-core processor.

The processor 802 may be created in accordance with an ARM architecture, available for license from ARM HOLDINGS of Cambridge, United Kingdom. Alternatively, the processor 802 may be created in accordance with an x86 architecture, such as is available from INTEL CORPORATION of Mountain View, Calif. and others. In some configurations, the processor 802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 804 include a random access memory (“RAM”) 814, a read-only memory (“ROM”) 816, an integrated storage memory (“integrated storage”) 818, and a removable storage memory (“removable storage”) 820. In some configurations, the RAM 814 or a portion thereof, the ROM 816 or a portion thereof, and/or some combination the RAM 814 and the ROM 816 is integrated in the processor 802. In some configurations, the ROM 816 is configured to store a firmware, an operating system or a portion thereof (e.g., operating system kernel), and/or a bootloader to load an operating system kernel from the integrated storage 818 and/or the removable storage 820.

The integrated storage 818 can include a solid-state memory, a hard disk, or a combination of solid-state memory and a hard disk. The integrated storage 818 may be soldered or otherwise connected to a logic board upon which the processor 802 and other components described herein also may be connected. As such, the integrated storage 818 is integrated in the computing device. The integrated storage 818 is configured to store an operating system or portions thereof, application programs, data, and other software components described herein.

The removable storage 820 can include a solid-state memory, a hard disk, or a combination of solid-state memory and a hard disk. In some configurations, the removable storage 820 is provided in lieu of the integrated storage 818. In other configurations, the removable storage 820 is provided as additional optional storage. In some configurations, the removable storage 820 is logically combined with the integrated storage 818 such that the total available storage is made available as a total combined storage capacity. In some configurations, the total combined capacity of the integrated storage 818 and the removable storage 820 is shown to a user instead of separate storage capacities for the integrated storage 818 and the removable storage 820.

The removable storage 820 is configured to be inserted into a removable storage memory slot (not shown) or other mechanism by which the removable storage 820 is inserted and secured to facilitate a connection over which the removable storage 820 can communicate with other components of the computing device, such as the processor 802. The removable storage 820 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 804 can store an operating system. According to various configurations, the operating system includes, but is not limited to WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 806 include a wireless wide area network component (“WWAN component”) 822, a wireless local area network component (“WLAN component”) 824, and a wireless personal area network component (“WPAN component”) 826. The network connectivity components 806 facilitate communications to and from the network 856 or another network, which may be a WWAN, a WLAN, or a WPAN. Although only the network 856 is illustrated, the network connectivity components 806 may facilitate simultaneous communication with multiple networks, including the network 756 of FIG. 6. For example, the network connectivity components 806 may facilitate simultaneous communications with multiple networks via one or more of a WWAN, a WLAN, or a WPAN.

The network 856 may be or may include a WWAN, such as a mobile telecommunications network utilizing one or more mobile telecommunications technologies to provide voice and/or data services to a computing device utilizing the computing device architecture 800 via the WWAN component 822. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 856 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 856 may be configured to provide voice and/or data communications with any combination of the above technologies. The network 856 may be configured to or adapted to provide voice and/or data communications in accordance with future generation technologies.

In some configurations, the WWAN component 822 is configured to provide dual-multi-mode connectivity to the network 856. For example, the WWAN component 822 may be configured to provide connectivity to the network 856, wherein the network 856 provides service via GSM and UNITS technologies, or via some other combination of technologies. Alternatively, multiple WWAN components 822 may be utilized to perform such functionality, and/or provide additional functionality to support other non-compatible technologies (i.e., incapable of being supported by a single WWAN component). The WWAN component 822 may facilitate similar connectivity to multiple networks (e.g., a UMTS network and an LTE network).

The network 856 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 824 is configured to connect to the network 856 via the WI-FI access points. Such connections may be secured via various encryption technologies including, but not limited, WI-FI Protected Access (“WPA”), WPA2, Wired Equivalent Privacy (“WEP”), and the like.

The network 856 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 826 is configured to facilitate communications with other devices, such as peripherals, computers, or other computing devices via the WPAN.

The sensor components 808 include a magnetometer 828, an ambient light sensor 830, a proximity sensor 832, an accelerometer 834, a gyroscope 836, and a Global Positioning System sensor (“GPS sensor”) 838. It is contemplated that other sensors, such as, but not limited to, temperature sensors or shock detection sensors, also may be incorporated in the computing device architecture 800.

The magnetometer 828 is configured to measure the strength and direction of a magnetic field. In some configurations the magnetometer 828 provides measurements to a compass application program stored within one of the memory components 804 in order to provide a user with accurate directions in a frame of reference including the cardinal directions, north, south, east, and west. Similar measurements may be provided to a navigation application program that includes a compass component. Other uses of measurements obtained by the magnetometer 828 are contemplated.

The ambient light sensor 830 is configured to measure ambient light. In some configurations, the ambient light sensor 830 provides measurements to an application program stored within one the memory components 804 in order to automatically adjust the brightness of a display (described below) to compensate for low-light and high-light environments. Other uses of measurements obtained by the ambient light sensor 830 are contemplated.

The proximity sensor 832 is configured to detect the presence of an object or thing in proximity to the computing device without direct contact. In some configurations, the proximity sensor 832 detects the presence of a user's body (e.g., the user's face) and provides this information to an application program stored within one of the memory components 804 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 832 are contemplated.

The accelerometer 834 is configured to measure proper acceleration. In some configurations, output from the accelerometer 834 is used by an application program as an input mechanism to control some functionality of the application program. For example, the application program may be a video game in which a character, a portion thereof, or an object is moved or otherwise manipulated in response to input received via the accelerometer 834. In some configurations, output from the accelerometer 834 is provided to an application program for use in switching between landscape and portrait modes, calculating coordinate acceleration, or detecting a fall. Other uses of the accelerometer 834 are contemplated.

The gyroscope 836 is configured to measure and maintain orientation. In some configurations, output from the gyroscope 836 is used by an application program as an input mechanism to control some functionality of the application program. For example, the gyroscope 836 can be used for accurate recognition of movement within a 3D environment of a video game application or some other application. In some configurations, an application program utilizes output from the gyroscope 836 and the accelerometer 834 to enhance control of some functionality of the application program. Other uses of the gyroscope 836 are contemplated.

The GPS sensor 838 is configured to receive signals from GPS satellites for use in calculating a location. The location calculated by the GPS sensor 838 may be used by any application program that requires or benefits from location information. For example, the location calculated by the GPS sensor 838 may be used with a navigation application program to provide directions from the location to a destination or directions from the destination to the location. Moreover, the GPS sensor 838 may be used to provide location information to an external location-based service, such as E911 service. The GPS sensor 838 may obtain location information generated via WI-FI, WIMAX, and/or cellular triangulation techniques utilizing one or more of the network connectivity components 806 to aid the GPS sensor 838 in obtaining a location fix. The GPS sensor 838 may also be used in Assisted GPS (“A-GPS”) systems.

The I/O components 810 include a display 840, a touchscreen 842, a data I/O interface component (“data I/O”) 844, an audio I/O interface component (“audio I/O”) 846, a video I/O interface component (“video I/O”) 848, and a camera 850. In some configurations, the display 840 and the touchscreen 842 are combined. In some configurations two or more of the data I/O component 844, the audio I/O component 846, and the video I/O component 848 are combined. The I/O components 810 may include discrete processors configured to support the various interface described below, or may include processing functionality built-in to the processor 802.

The display 840 is an output device configured to present information in a visual form. In particular, the display 840 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 840 is a liquid crystal display (“LCD”) utilizing any active or passive matrix technology and any backlighting technology (if used). In some configurations, the display 840 is an organic light emitting diode (“OLED”) display. Other display types are contemplated.

The touchscreen 842, also referred to herein as a “touch-enabled screen,” is an input device configured to detect the presence and location of a touch. The touchscreen 842 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 842 is incorporated on top of the display 840 as a transparent layer to enable a user to use one or more touches to interact with objects or other information presented on the display 840. In other configurations, the touchscreen 842 is a touch pad incorporated on a surface of the computing device that does not include the display 840. For example, the computing device may have a touchscreen incorporated on top of the display 840 and a touch pad on a surface opposite the display 840.

In some configurations, the touchscreen 842 is a single-touch touchscreen. In other configurations, the touchscreen 842 is a multi-touch touchscreen. In some configurations, the touchscreen 842 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 842. As such, a developer may create gestures that are specific to a particular application program.

In some configurations, the touchscreen 842 supports a tap gesture in which a user taps the touchscreen 842 once on an item presented on the display 840. The tap gesture may be used for various reasons including, but not limited to, opening or launching whatever the user taps. In some configurations, the touchscreen 842 supports a double tap gesture in which a user taps the touchscreen 842 twice on an item presented on the display 840. The double tap gesture may be used for various reasons including, but not limited to, zooming in or zooming out in stages. In some configurations, the touchscreen 842 supports a tap and hold gesture in which a user taps the touchscreen 842 and maintains contact for at least a pre-defined time. The tap and hold gesture may be used for various reasons including, but not limited to, opening a context-specific menu.

In some configurations, the touchscreen 842 supports a pan gesture in which a user places a finger on the touchscreen 842 and maintains contact with the touchscreen 842 while moving the finger on the touchscreen 842. The pan gesture may be used for various reasons including, but not limited to, moving through screens, images, or menus at a controlled rate. Multiple finger pan gestures are also contemplated. In some configurations, the touchscreen 842 supports a flick gesture in which a user swipes a finger in the direction the user wants the screen to move. The flick gesture may be used for various reasons including, but not limited to, scrolling horizontally or vertically through menus or pages. In some configurations, the touchscreen 842 supports a pinch and stretch gesture in which a user makes a pinching motion with two fingers (e.g., thumb and forefinger) on the touchscreen 842 or moves the two fingers apart. The pinch and stretch gesture may be used for various reasons including, but not limited to, zooming gradually in or out of a web site, map, or picture.

Although the above gestures have been described with reference to the use one or more fingers for performing the gestures, other appendages such as toes or objects such as styluses may be used to interact with the touchscreen 842. As such, the above gestures should be understood as being illustrative and should not be construed as being limiting in any way.

The data I/O interface component 844 is configured to facilitate input of data to the computing device and output of data from the computing device. In some configurations, the data I/O interface component 844 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 846 is configured to provide audio input and/or output capabilities to the computing device. In some configurations, the audio I/O interface component 846 includes a microphone configured to collect audio signals. In some configurations, the audio I/O interface component 846 includes a headphone jack configured to provide connectivity for headphones or other external speakers. In some configurations, the audio I/O interface component 846 includes a speaker for the output of audio signals. In some configurations, the audio I/O interface component 846 includes an optical audio cable out.

The video I/O interface component 848 is configured to provide video input and/or output capabilities to the computing device. In some configurations, the video I/O interface component 848 includes a video connector configured to receive video as input from another device (e.g., a video media player such as a DVD or BLURAY player) or send video as output to another device (e.g., a monitor, a television, or some other external display). In some configurations, the video I/O interface component 848 includes a High-Definition Multimedia Interface (“HDMI”), mini-HDMI, micro-HDMI, DisplayPort, or proprietary connector to input/output video content. In some configurations, the video I/O interface component 848 or portions thereof is combined with the audio I/O interface component 846 or portions thereof.

The camera 850 can be configured to capture still images and/or video. The camera 850 may utilize a charge coupled device (“CCD”) or a complementary metal oxide semiconductor (“CMOS”) image sensor to capture images. In some configurations, the camera 850 includes a flash to aid in taking pictures in low-light environments. Settings for the camera 850 may be implemented as hardware or software buttons.

Although not illustrated, one or more hardware buttons may also be included in the computing device architecture 800. The hardware buttons may be used for controlling some operational aspect of the computing device. The hardware buttons may be dedicated buttons or multi-use buttons. The hardware buttons may be mechanical or sensor-based.

The illustrated power components 812 include one or more batteries 852, which can be connected to a battery gauge 854. The batteries 852 may be rechargeable or disposable. Rechargeable battery types include, but are not limited to, lithium polymer, lithium ion, nickel cadmium, and nickel metal hydride. Each of the batteries 852 may be made of one or more cells.

The battery gauge 854 can be configured to measure battery parameters such as current, voltage, and temperature. In some configurations, the battery gauge 854 is configured to measure the effect of a battery's discharge rate, temperature, age and other factors to predict remaining life within a certain percentage of error. In some configurations, the battery gauge 854 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 812 may also include a power connector, which may be combined with one or more of the aforementioned I/O components 810. The power components 812 may interface with an external power system or charging equipment via an I/O component.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computer-implemented method comprising:
receiving, at a computing device, scheduling data defining a first calendar event;
obtaining contextual data, at the computing device, from a plurality of resources;
determining, at the computing device, if the first calendar event presents a conflict with a second calendar event, wherein the presence of the conflict is based, at least in part, on aspects of the contextual data meeting one or more criteria;
generating data defining an insight describing aspects of the conflict; and
causing a display of one or more graphical elements indicating the insight on a user interface of the computing device or one or more computing devices.

2. The method of claim 1, wherein generating data defining the insight comprises generating a text description summarizing the conflict, wherein the one or more graphical elements are configured to display the text description on the user interface of the computing device.

3. The method of claim 1, wherein generating data defining the insight comprises generating a value indicating a severity of the conflict, wherein the one or more graphical elements indicate the value indicating the severity of the conflict.

4. The method of claim 3, wherein the severity of the conflict is based on a degree of overlap between the first calendar event and the second calendar event.

5. The method of claim 1, wherein generating data defining the insight comprises:
analyzing a first start time or a first end time of the first calendar event in relation to a second start time or a second end time of the second calendar event; and
determining a probability of a commute associated with the first calendar event and the second calendar event based at least, on the first start time, first end time, second start time, or the second end time, wherein the insight comprises data indicating the probability of the commute.

6. The method of claim 5, wherein the insight includes a text description indicating the probability of the commute.

7. The method of claim 5, wherein the method further comprises, obtaining map data, and wherein the insight includes a graphical element including a map illustrating aspects of the commute.

8. The method of claim 5, wherein the method further comprises:
obtaining weather data;
determining if aspects of the weather data impact the commute; and
generating the insight based, at least in part, on the weather data if aspects of the weather data impact the commute.

9. The method of claim 5, wherein the method further comprises:
obtaining traffic data;
determining if aspects of the traffic data impact the commute; and
generating the insight based, at least in part, on the weather data if aspects of the traffic data impact the commute.

10. The method of claim 9, wherein the wherein the insight includes data configured to display a projection of one or more traffic conditions or one or more traffic patterns at or near the first start time, first end time, second start time, or the second end time.

11. The method of claim 1, further comprising:
receiving work history data defining one or more performance indicators associated with a first provider associated with the first calendar event or the second calendar event; and
generating the insight based, at least in part, on the work history data.

12. The method of claim 1, further comprising:
receiving workflow data defining a multistep process;
determining if the first calendar event or the second calendar event present a conflict with respect to the multistep process;
generating the insight based, at least in part, on the workflow data if the first calendar event or the second calendar event present a conflict with respect to the multistep process.

13. The method of claim 1, wherein the contextual data comprises at least one of scheduling data, workload data, work history data, payment data, weather data, map data, traffic data, or location data.

14. A system, comprising:
a processor; and
a memory in communication with the processor, the memory having computer-readable instructions stored thereupon that, when executed by the processor, cause the system to perform a method comprising
receiving scheduling data defining a calendar event;
obtaining contextual data from a plurality of resources, the contextual data including at least one of scheduling data, workload data, work history data, payment data, weather data, map data, traffic data, or location data;
identifying a pattern of the contextual data indicating a presence of a condition that affects the calendar event;
generating data defining an insight describing aspects of the condition; and
causing a display of one or more graphical elements indicating the insight on a user interface rendered on a display device in communication with the system.

15. The system of claim 14, wherein generating data defining the insight comprises generating a ranked list of items, wherein individual items of the ranked list of items comprise resolutions configure to cause a generation or a modification of a data object to provide notice of the condition.

16. The system of claim 14, wherein generating data defining the insight comprises generating a ranked list of items, wherein individual items of the ranked list of items comprise resolutions configure to cause a generation or a modification of a data object to resolve a scheduling conflict.

17. The system of claim 14, wherein generating data defining the insight comprises causing a generation of one or more graphical elements comprising a text description summarizing the condition, wherein the one or more graphical elements are configured to display the text description on the user interface of the computing device.

18. The system of claim 14, wherein generating data defining the insight comprises causing a generation of one or more graphical elements comprising an image of a map illustrating the condition, wherein the one or more graphical elements are configured to display the map on the user interface of the computing device.

19. The system of claim 14, wherein identifying the pattern of the contextual data indicating the presence of the condition that affects the calendar event comprises:
generating a value indicating a severity of the condition; and
identifying the pattern of the contextual data indicating the presence of the condition that affects the calendar event when the value meets or exceeds one or more criteria.

20. The system of claim 19, wherein the value of the severity of the condition is based, at least in part, on a degree of overlap or a threshold amount of time between the calendar event and another calendar event.

21. The system of claim 19, wherein the value of the severity of the condition is based, at least in part, on a time between the calendar event and another calendar event and a commute time associated with the calendar event.

22. One or more computer-readable storage media storing instructions that, when executed by one or more processors of a computing device, perform operations comprising:
receiving scheduling data defining a calendar event;
obtaining contextual data from a plurality of resources, the contextual data including at least one of scheduling data, workload data, work history data, payment data, weather data, map data, traffic data, or location data;
identifying a pattern of the contextual data indicating a presence of a condition that affects the calendar event;
generating data defining an insight describing aspects of the condition; and
causing a display of one or more graphical elements indicating the insight on a user interface of the computing device or on a user interface rendered on a display device in communication with the computing device.

23. The one or more computer-readable storage media of claim 22, wherein generating data defining the insight comprises generating a ranked list of items, wherein individual items of the ranked list of items comprise resolutions configure to cause a generation or a modification of a data object to provide notice of the condition.

24. The one or more computer-readable storage media of claim 22, wherein generating data defining the insight comprises generating a ranked list of items, wherein individual items of the ranked list of items comprise resolutions configure to cause a generation or a modification of a data object to resolve a scheduling conflict.

25. The one or more computer-readable storage media of claim 22, wherein generating data defining the insight comprises causing a generation of one or more graphical elements comprising a text description summarizing the condition, wherein the one or more graphical elements are configured to display the text description on the user interface of the computing device.

26. The one or more computer-readable storage media of claim 22, wherein generating data defining the insight comprises causing a generation of one or more graphical elements comprising an image of a map illustrating the condition, wherein the one or more graphical elements are configured to display the map on the user interface of the computing device.

27. The one or more computer-readable storage media of claim 22, wherein identifying the pattern of the contextual data indicating the presence of the condition that affects the calendar event comprises:
generating a value indicating a severity of the condition; and
identifying the pattern of the contextual data indicating the presence of the condition that affects the calendar event when the value meets or exceeds one or more criteria.

28. The one or more computer-readable storage media of claim 27, wherein the value of the severity of the condition is based, at least in part, on a degree of overlap or a threshold amount of time between the calendar event and another calendar event.

29. The one or more computer-readable storage media of claim 27, wherein the value of the severity of the condition is based, at least in part, on a time between the calendar event and another calendar event and a commute time associated with the calendar event.
